(19) United States
(12) Patent Application Publication
(10) Pub. No.: US 2017/0178007 A1
(43) Pub. Date: Jun. 22, 2017

(54) PREDICTIVE ANALYTICS ARCHITECTURE FOR EVENT PROCESSING

(71) Applicant: Beijing Chuangxin Journey Network Technology Co., Ltd, Beijing (CN)

(72) Inventors: Jin Yu, Union City, CA (US); Xunhui Yu, North Wales, PA (US)

(21) Appl. No.: 14/973,754

(22) Filed: Dec. 18, 2015

(51) Int. Cl. G06N 5/04; G06N 99/00

(52) U.S. Cl. CPC G06N 5/04; G06N 99/005

(57) ABSTRACT

Techniques described herein include an event notification processing platform configured to provide users with recommendations in relative real-time based on generated event notifications. In some embodiments, an event source associated with one or more users may generate an event notification, indicating that an event has occurred with respect to a user. The system may process the event notification with respect to the user in order to identify one or more recommendations. In some embodiments, the system may identify a number of attribute values associated with the user that are relevant to a prediction result set. The platform may use one or more machine learning techniques to identify, based on those attribute values, the most appropriate recommendations for the user.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

As more and more consumer data becomes available, there is a drive to find new and useful ways to use that data. In some cases, data related to consumer actions (such as surfing the internet, running an application, or entering a geographic location) may be provided to one or more third parties as event notifications. When a large number of consumers are each producing multiple event notifications, the consumer information stored in a data log may comprise a very large amount of data (e.g., billions of events per day). Sorting through this data to identify information that is useful to a particular user can often take days. As a result, conventional event processing platforms may provide outdated information.

### BRIEF SUMMARY OF THE INVENTION

Described herein are techniques for implementing a predictive modeling platform for providing user predictions based on event notifications. In some embodiments, event notifications are received at an edge node from one or more event sources. An event source may be any user device, application, or module configured to generate an event notification in response to detecting a user interaction. An edge node may be any device capable of receiving and publishing event notifications from one or more event sources. Event notifications published by an edge node may be delivered to a log aggregator for publication into an event stream. A log aggregator may be any computing devices that is configured to receive event notifications from one or more edge nodes and combine them into a single log (or event stream).

In accordance with the disclosure, the predictive modeling platform may utilize a predictive model. A predictive model may comprise various machine learning algorithms, variable values consumed by the machine learning algorithms, weights to be associated with result sets produced by the various machine learning algorithms and/or any other suitable analytics data. The predictive model may be created, maintained, and improved by machine learning modules (UBML), and configured to run one or more machine learning algorithms on the historical events received from log aggregators. In this way, the predictive model is continuously trained, updated, and improved as events related to user behavior are processed.

Event notifications published by a log aggregator may be retrieved and processed according to the predictive model. This predictive model may use a variety of machine learning techniques to generate a prediction result set that includes an indication of a user's likely interests. In addition, the predictive model may access user information such as purchase history, website interaction data, user demographics, or any other suitable user information. Because the platform is scalable (multiple instances of a predictive model may be instantiated as needed), the predictive model may be trained on the complete set of event notifications instead of just a subset of the event notifications.

Furthermore, the platform may be configured to receive feedback from the user, which may subsequently be used to train the predictive model. For example, information from a prediction result set generated using a particular algorithm may be presented to a user. The user may subsequently provide an indication as to the accuracy of the prediction result set, which may be used to train the predictive model (e.g, by adjusting the assumptions or variables used in the algorithm). In some cases, two prediction result sets may be generated and two respective options may be presented to the users. In these cases, a certain percentage of the users may be presented one option, and remaining users may be presented with a second option (known as AB testing). By comparing user interaction patterns with these two options, the results may be used to determine which prediction result set is most accurate. The two prediction result sets may be generated using two separate predictive models or they may be generated using a single predictive model using different assumptions.

### BRIEF DESCRIPTION OF THE DRAWINGS

Various embodiments in accordance with the present disclosure will be described with reference to the drawings, in which:

FIG. 1 depicts an illustrative predictive analytics event processing system in accordance with at least some embodiments;

FIG. 2 depicts an illustrative example event processing platform for providing predictive modeling based on event notifications in real-time in accordance with at least some embodiments;

FIG. 3 depicts a diagram that illustrates an example of a data communication flow and presentation in accordance with at least some embodiments of the disclosure;

FIG. 4 depicts an illustrative flow diagram demonstrating an example technique for providing prediction result sets based on event notification in accordance with at least some embodiments;

FIG. 5 depicts an illustrative flow diagram demonstrating an example technique for providing a recommendation based on user data in accordance with at least some embodiments; and

FIG. 6 depicts aspects of elements that may be present in a computer device and/or system configured to implement a method and/or process in accordance with some embodiments of the present invention.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described herein include a system and architecture for predicting user behavior/interest in real-time based on event notifications. In embodiments of the disclosure, one or more edge node devices are used to retrieve event notifications from event sources. The event notifications are aggregated into a single event stream and processed by one or more processing devices. A predictive model may include various machine learning algorithms that may be applied to the event notifications in the event stream to predict user interests. In some embodiments, feedback may be received from the user, which may subsequently be used to improve the accuracy of the machine learning algorithms used by the predictive model.

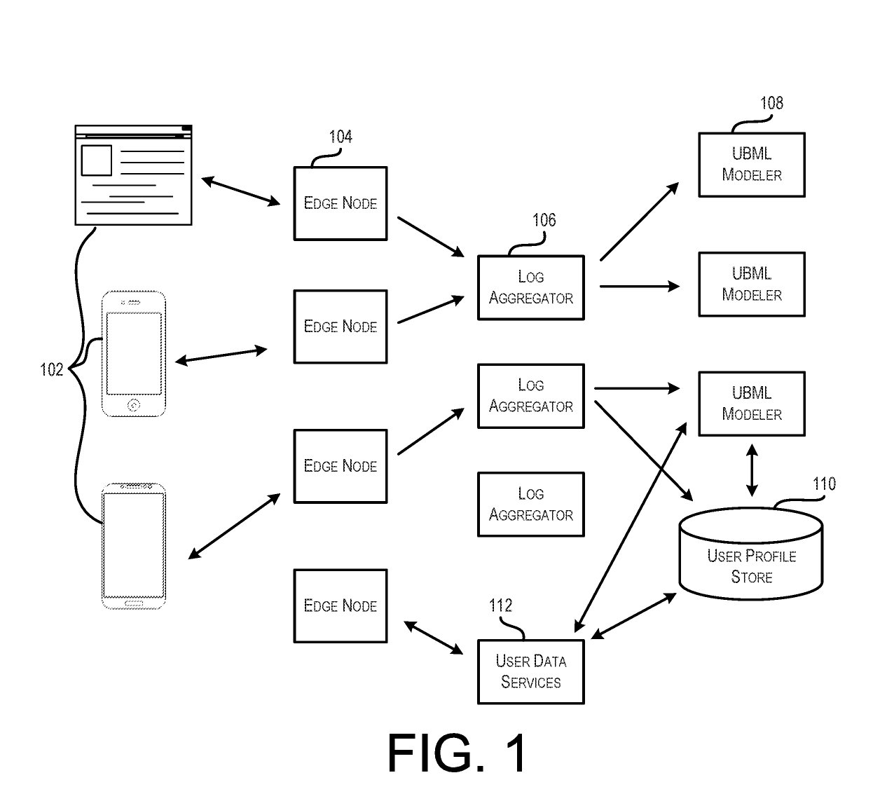

FIG. 1 depicts an illustrative predictive analytics event processing system in accordance with at least some embodiments. In FIG. 1, a plurality of event sources 102 are depicted. In accordance with at least some embodiments, an event source 102 may be any device or application capable of providing an event notification related to a user event. For example, an event source may be a web browser, a mobile phone, an application installed on a client device, or any other suitable source of event notifications. Event sources 102 may transmit event notifications when one or more events have occurred. For example, when a user visits a website, an event source 102 may transmit an event notification that indicates that the user has visited the website.

Event notifications may be received at an edge node 104. An edge node may be any device capable of receiving event notifications from one or more event sources 102 and publishing them so that they may be retrieved by a log aggregator 106. In some embodiments, an edge node 104 may receive event notifications from multiple event sources 102. Event notifications may be stored on an edge node 104 for a predetermined period of time. For example, an edge node 104 may be configured to store event notifications for seven days. After that time, the edge node 104 may purge or delete the event notification to free up memory.

Log aggregators 106 may be any computing devices that are configured to retrieve event notifications from one or more edge nodes 104 and combine them into a single log. A log may be any means of publishing a series of events. In some embodiments, the log may be a database table in a data store. In some embodiments, the log may be a text file. Event notifications may be stored at the log aggregator 106 for a predetermined period of time. In some embodiments, multiple log aggregators 106 may retrieve event notifications from the same edge node 104.

One or more user behavior machine learning (UBML) modeler 108 may be configured to retrieve event notifications from one or more log aggregators 106. The UBML modelers may be any computing device, module, or application configured to apply one or more predictive models to the retrieved event notification. In some embodiments, the UBML modeler 108 may be configured to generate a prediction result set from a combination of the retrieved event and information from a profile of the user associated with the event notification using the predictive model. For example, the UBML modeler may retrieve an event notification from a log aggregator that indicates User A has interacted with a travel website. In this example, the UBML modeler may access past user purchase history related to User A in a user profile store 110. One or more algorithms of the predictive model may then be utilized in order to identify locations that User A may be interested in traveling to.

The user profile store 110 may read events from the log aggregator and update user information accordingly. In some embodiments, the user associated with an event notification may be identified based on the user's association with the event source. For example, the user may be associated with a particular mobile phone device from which an event notification is generated. In this scenario, the user may be associated with any event notification generated by the mobile phone device. In some cases, the user may be required to log into an account in order to generate events. In these cases, the user may be associated with any event notification generated by the user account. The user profile store 110 may store a user's user identifier, declared demographic information (e.g., age, gender, education, etc.), predicted demographic information (e.g., information about a user that is predicted using machine learning techniques), user preferences, computed user intent (e.g., information about a user's intention or interests), time series data (e.g., information related to a user's historical interactions with network content), or any other suitable user-related attributes. Time series data may include any data related to a user's interactions with content, such as a user's viewing of a website, publishing of content, purchasing of products, etc. For example, time series data may include a user's browsing history (e.g., browsing products, travel destinations, etc.), a user's purchasing history, and/or a user's generated content (e.g., forum posts, blogs, tweets, likes, etc).

Once a prediction result set has been generated for the user associated with the event notification, user data services 112 may be implemented to provide information associated with the user to the edge node. Given a user identifier, user data services 112 may be configured to provide information from a user profile to the edge node and/or user data services 112 may be configured to provide information related to an item from the prediction result set that a user may be interested in. For example, a user may purchase a flight from a travel website. In this example, the purchase of the flight may be provided as an event notification to one or more UBML modelers 108. If a predictive model determines, using one or more algorithms, that the user may be interested in booking a hotel at the location, then the predictive model and/or the user data services 112 may compile a list of potential hotels with vacancies. In some embodiments, the predictive model or the user data services 112 may identify a subset of hotels from the list of hotels that the user would likely be interested in based on indicated preferences or the purchase history of the user and provide the subset to the user. The user may subsequently select one of the hotels in the provided subset. In this example, the user's election of a hotel may be used to further refine predictions made by the predictive model.

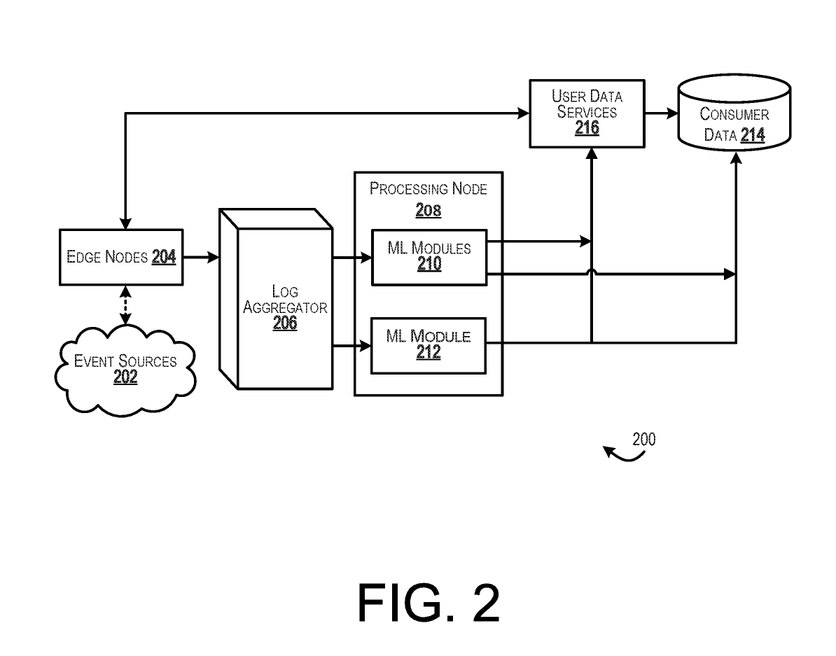

FIG. 2 depicts an illustrative example event processing platform 200 for providing prediction result sets based on event notifications in real-time in accordance with at least some embodiments. Each component of the depicted platform may represent one or more special purpose devices configured to perform the described functions. In some embodiments, each component of the platform may comprise a cluster or group of devices that each perform the same, or a similar, function.

An event source 202 is any application or module configured to report an event triggered by a user, to include a request made by an application or a webpage request. For example, a user electing to visit a website may trigger an event. Likewise, a change in a user's geographical location or status may also trigger an event. As there may be a multitude of potential event triggers, there may be a multitude of event sources 202 for any particular embodiment of the current disclosure. An event may be reported via an event notification. A series of event notifications may be referred to as an event stream.

An edge node 204 may be any device, application, or module configured to listen to different event sources 202 and publish event notifications to one or more log aggregator 206. In some embodiments, an edge node 204 may be a server or other computing device configured to listen to one or more event sources 202. Because notifications of events are received from different types of event sources 202, some embodiments of the disclosure may include edge nodes that are configured to listen to an event stream from a particular event source 202. Each event notification may be associated with an event type that describes the event and/or a timestamp indicating the time at which the event occurred. A single event type may be associated with multiple edge nodes 204. For example, a particular event type may be received from a number of different event sources 202 and related event notifications may be published from a number of different edge nodes 204.

A log aggregator 206 may be an application or module configured to combine event streams published by one or more edge nodes 204 into a single event stream. In other words, the log aggregator 206 aggregates the event notifications from multiple edge nodes 204 and records them in a single log that may be accessed by multiple stream processing nodes 208. In some embodiments, the log aggregator 206 may comprise a server or other computer configured to listen to edge nodes, extract event notifications, and write the extracted event notifications to one or more logs. In some embodiments, a log aggregator 206 may be configured to retrieve event notification data from one or more edge nodes 204. Event notifications may be associated with a timestamp and/or an offset number. In some embodiments, the log aggregator may maintain separate logs based on the type of event. For example, event notifications related to a user's change in geographic location may be stored in a log separate from event notifications related to a user's request for a website. In this example, the log aggregator may write all location update event notifications to a single log. In some embodiments, separate processing nodes 208 may be used to access one or more separate logs based on the type of event notifications stored in the log. In some embodiments, the log aggregator 206 may be configured to store event notifications for a pre-determined period of time. For example, the log aggregator 206 may store event notifications for seven days. In this example, event notifications may expire, or may be deleted from logs, after seven days.

A machine-learning (ML) module 210 or 212 is an application or module configured to retrieve event notifications from the log aggregator 206 and subject the retrieved event notifications to a predictive model to predict, based on the event associated with the event notification, at least one item (e.g., a good, service, or content) that a user associated with the event notification may be interested in. In at least some embodiments, the machine-learning module may be configured to access consumer data 214. For example, upon receiving an event notification related to User A, the machine-learning module 210 may access consumer data 214 in order to retrieve one or more attribute values related to User A. The attribute values may then be used by the predictive model to create a prediction result set that includes one or more items that the user may be interested in. For example, the machine learning module 210 may determine that there a particular event type is highly correlated to a user purchasing a particular good or service. In this example, upon receiving an event notification related to the particular event type, the prediction result set may include a list of the good or service that the user is likely to purchase. Once the prediction result set has been generated, it may be provided to user data services 216. User data services 216 may be any application or module configured to receive prediction result sets from one or more machine-learning module 210 and/or 212 and provide recommendations to the user. Additionally, the user data services 216 may be configured to receive feedback from the user, which may subsequently be used to update one or more predictive models.

A machine-learning module 210 may be configured to recognize patterns in user behavior and purchasing and construct algorithms that may be used in a predictive model to predict future behavior. As feedback is received by the machine-learning module 210, it may adjust variables associated with the predictive model in order to improve the accuracy of result sets produced using the predictive model. Each of machine-learning modules 210 and 212 may utilize a different predictive model. Additionally, multiple predictive models may be used to process a single event notification. For example, a first machine-learning module 210 may utilize a predictive model that utilizes a logistic regression technique and a second machine-learning module 212 may utilize a predictive model that utilizes a decision tree technique. In this example, both predictive models may create prediction result sets for a single event notification. In some cases, the prediction result sets may be combined to create a hybrid result set. In some embodiments, AB testing may be used to determine which predictive model is most effective for the current event notification. For example, a first item from the prediction result set created by machine-learning module 210 may be provided to the user alongside a second item from the prediction result set created by machine-learning module 212. In this example, the user data services 216 may receive an indication that either the first or the second item is preferred. The user data services 216 may subsequently determine that one predictive model or the other was most effective in processing the particular event notification. By way of a second example, a first item from the prediction result set created using a predictive model with a first set of variables may be provided to the user alongside a second item from the prediction result set created using the same predictive model with a second set of variables. In this example, the user data services 216 may receive an indication that either the first or the second item is preferred. The user data services 216 may subsequently determine that one set of variables or the other is more effective.

Event notifications may be processed by a particular machine-learning module 210 or 212 according to the type of event associated with the event notification. For example, all event notifications associated with a user visiting a website may be processed by machine-learning module 210 whereas all event notifications associated with a user entering a geographic area may be processed by machine-learning module 212. This may be done to ensure that event notifications associated a particular event type are processed using a particular predictive model or machine-learning technique. Alternatively, event streams may be directed to one or more machine-learning module 210 or 212 based on load balancing. For example, 40% of event notifications may be processed by two machine-learning modules using a logistic regression technique and 60% of event notifications may be processed by three machine-learning modules using a decision tree technique.

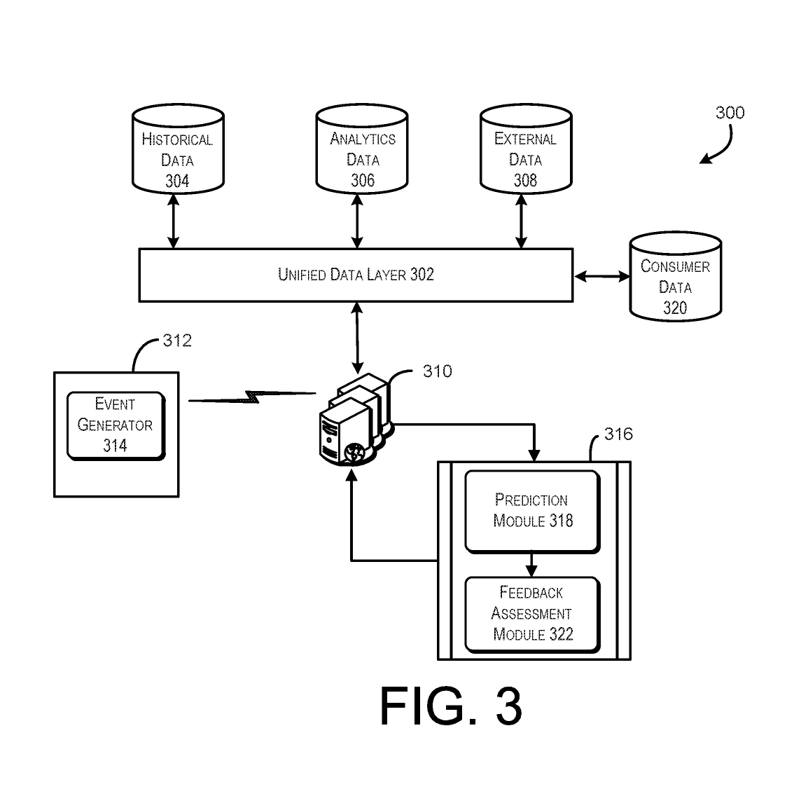

FIG. 3 depicts a diagram 300 that illustrates an example of a data communication flow and presentation in accordance with at least some embodiments of the disclosure. In FIG. 3, a unified data layer 302 is depicted as a data layer interacting with data from various data stores 304, 306, and 308. Data stores 304, 306, and 308 may include one or more separate data sources containing historical data 304 (e.g., data related to product purchasing trends, past travel data, etc.), analytics data 306 (e.g., data related to statistical analysis of user interactions, etc.), data provided by external entities 308 (entities external to a service provider 310), or any other suitable data. The unified data layer 302 may aggregate and store data from any number of data stores 304, 306 and 308. Data stored in a unified data layer may be updated from data stores dynamically as new information is received.

In accordance with at least one embodiment, unified data layer 302 may be stored on, or accessible by, a service provider 310. Service provider 310 is any provider of one or more of the services disclosed, and may include one or more edge nodes, one or more log aggregators, and any other suitable computing devices. For example, a service provider 310 may encompass the event processing platform 200 of FIG. 2. In addition to accessing data located in unified data layer 302, service provider 310 may send data to or receive data from a user device 312. User devices 312 may be any type of computing device such as, but not limited to, a mobile phone, a smart phone, a personal digital assistant (PDA), a laptop computer, a desktop computer, a server computer, a thin-client device, a tablet PC, etc. User device 312 may be a mobile device in accordance with at least some embodiments. User device 312 may contain a number of sensors via which input data may be received. Through user device 312, service provider 310 may receive data from a user via an event generator 314. An event generator 314 may be any application installed on a user device 312 that is capable of generating an event notification. For example, a web browser application installed on user device 312 may generate event notifications related to a user's internet usage.

The event notification received by service provider 310 may be processed at sub-process 316. In sub-process 316, a prediction module 318 may query one or more datasets of the unified data layer to identify event/item correlations. The prediction module 318 may be configured to utilize one or more machine learning techniques in order to develop a predictive model for predicting future user behavior based on past user data. Additionally, the prediction module 318 may be configured to query one or more datasets of a consumer data store 320 to identify attribute values related to a user associated with the event notification received and feed that user-specific data to the predictive model. For example, the prediction module 318 may determine that users over 55 are highly correlated to the purchase of Hawaiian vacations. The predictive model may then be configured to assign a high likelihood of user interest in Hawaiian vacations to consumers 55 years of age and over. If the prediction module 318 receives an event notification that indicates that a user is searching for a vacation destination, it may query the unified data layer 302 to determine demographic information, which may then be provided, along with the event notification, to the predictive model. If the user is determined to be a 65 year old, the predictive model may generate a recommendation for a trip to Hawaii for that user. In some embodiments, one or more clustering techniques may be used to cluster or group similarly situated users. Once grouped, the prediction module 318 may identify a purchase history for one or more grouped users. Accordingly, the prediction module 318 may determine the user's likelihood of interest in a particular item based on similarly situated users' purchase histories.

The unified data layer 302 may contain information related to historical user interactions collected from event notifications or other sources. For an illustrative example, the unified data layer 302 may store a user's interactions with a travel website, a user's travel log or itinerary, forums visited by the user, item reviews provided by the user, or any other suitable travel-related data. In this example, the service provider 310 may receive an event notification indicating that the user has just visited a travel booking website, and may determine that the user is interested in booking a vacation. The prediction module 318 may then predict, from the user's travel-related information, one or more locations that the user is likely to travel to as well as goods and/or services related to the predicted locations. In this example, the prediction module 318 may compile a list of hotels, flights, activities, and/or car rentals associated with the location. In some embodiments, the prediction module 318 may use the user's data or indicated preferences to filter the compiled list. In the current example, the prediction module 318 may determine that the user typically prefers to stay at a particular hotel chain, at a particular quality of hotels (four stars or above, etc.), or at hotels having specific amenities (e.g., free breakfast, gym, pool, etc.). The prediction module 318 may then rank or re-order the list of filtered items according to the user's predicted interest in each item.

Once a prediction result set has been generated, a feedback assessment module 322 may be configured to assess the accuracy of a prediction result set generated by the prediction module 318 based on feedback received from user device 312. In some embodiments, results from multiple prediction result sets may be provided to a user via user device 312. The feedback assessment module 322 may receive an indication of which results the user prefers and may determine that the prediction result set associated with those results is more accurate. This is typically referred to as A/B testing. In some embodiments, the feedback may be received via a second event notification. For example, two prediction result sets may be generated that each predict the user is likely to be interested in a different item. In this example, the two items may be presented to the user. The user may subsequently elect to purchase one of the presented items and the user device 312 may generate a new event notification related to the purchase. Upon receiving the new event notification, the assessment module may determine that the prediction result set that predicted the user would be interested in the purchased item was more accurate than the other prediction result set.

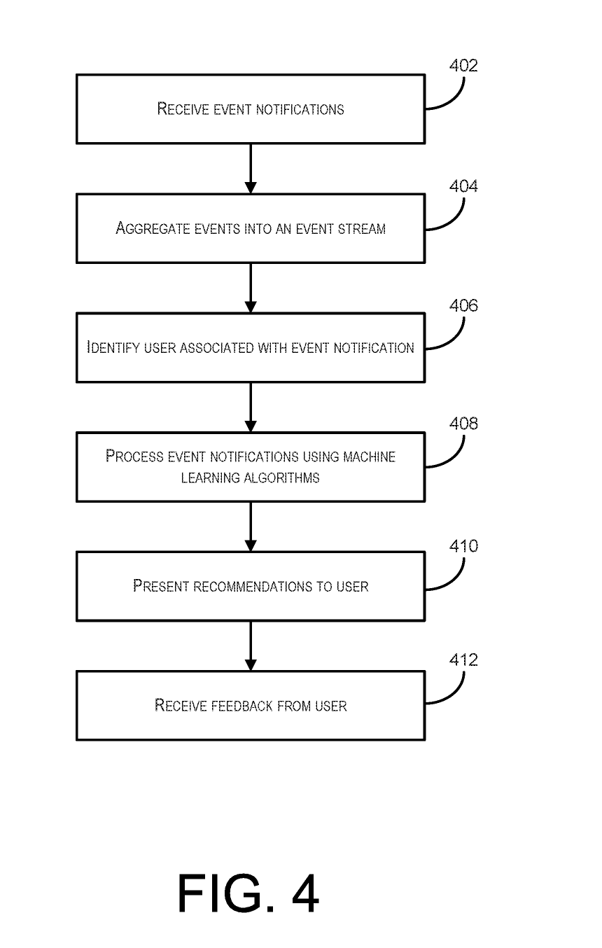

FIG. 4 depicts an illustrative flow diagram demonstrating an example technique for providing prediction result sets based on event notification in accordance with at least some embodiments. The process 400 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 400 (or any other processes described herein, or variations and/or combinations thereof) may be performed under the control of one or more computer systems configured with executable instructions and may be implemented as code (e.g., executable instructions, one or more computer programs or one or more applications). The code may be stored on a computer-readable storage medium, for example, in the form of a computer program including a plurality of instructions executable by one or more processors. The computer-readable storage medium may be non-transitory.

Process 400 may begin at 402 when one or more event notifications are received at a service provider from one or more event sources. For example, the service provider may receive a number of event notifications from multiple user devices. The event notifications may be aggregated into a single log (or event stream) at 404. The service provider may identify one or more users associated with the user device that generated the event notification at 406. The service provider may then process each notification according to one or more sets of rules and provide data related to one or more users of the multiple user devices. For example, one or more predictive models may be used to process the event data at 408. The data from the processed events may be stored at a data memory store in relation to the user. In some embodiments, the service provider may store old and/or outdated data for one or more users that is updated or replaced by data processed from the event notifications. For example, the event notifications may contain location data for the user that is processed by the service provider. In this example, the service provider may track the user's current location. As each event notification is received from the user's user device, the service provider may identify location information and update the data store with the user's current location. In some embodiments, the service provider may also store the user's historical location data, or the data related to other locations that the user has visited. Either current data or historical data may be used to make user recommendations. Once the recommendation is made to the user at 410, the service provider may receive feedback from the user regarding the recommendation at 412. For example, the service provider may recommend a product to the user and the user may purchase the product recommended by the service provider. The purchase of the product by the user may generate an event notification that may subsequently be used to train the predictive model.

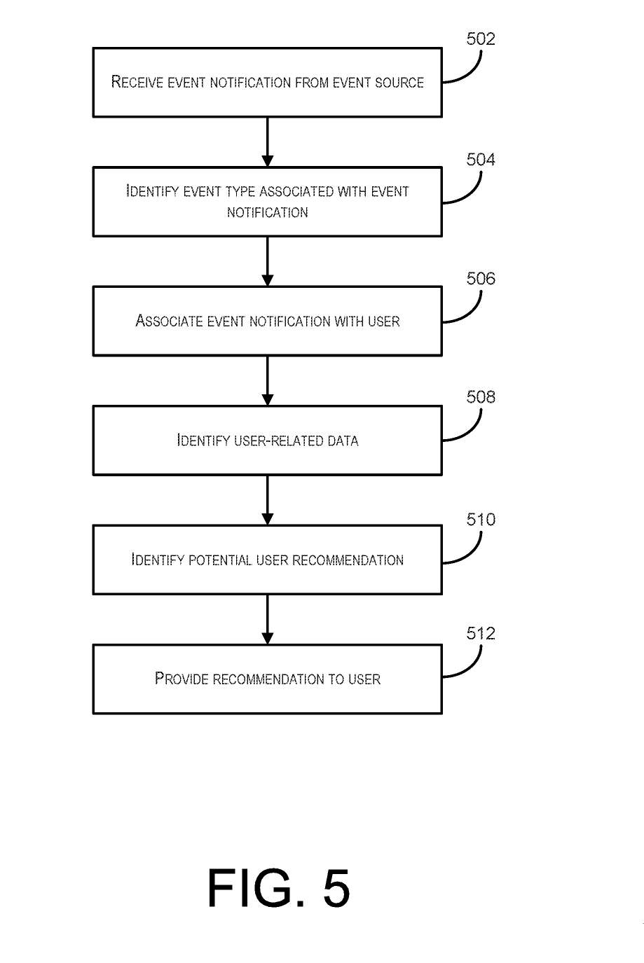

FIG. 5 depicts an illustrative flow diagram demonstrating an example technique for providing a recommendation based on user data in accordance with at least some embodiments. The process 500 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Process 500 may begin at 502 when one or more event notifications are received at a service provider from one or more event sources. Each event notification is generated in response to an event, and may include an indication of the type of event that resulted in the event notification. The service provider may identify the event type associated with the event notification at 504. The service provider may also identify one or more users associated with the user device that generated the event notification at 506. Once a user has been identified as being associated with the event notification, the service provider may identify a number of attribute values associated with the user at 508.

The service provider may use one or more predictive models to identify potential user recommendations at 510. For example, the service provider may identify one or more patterns associated with a group of users and/or an electronic catalog and identify how the patterns may relate to a particular user. More particularly, the service provider may identify correlations between events related to users and purchase history. In this example, a predictive model may be used to identify recommendations that may be relevant to the user based on attributes associated with that user and purchasing patterns. The recommendation may be presented to the user at 512. Feedback received from the user may be used to train the predictive model.

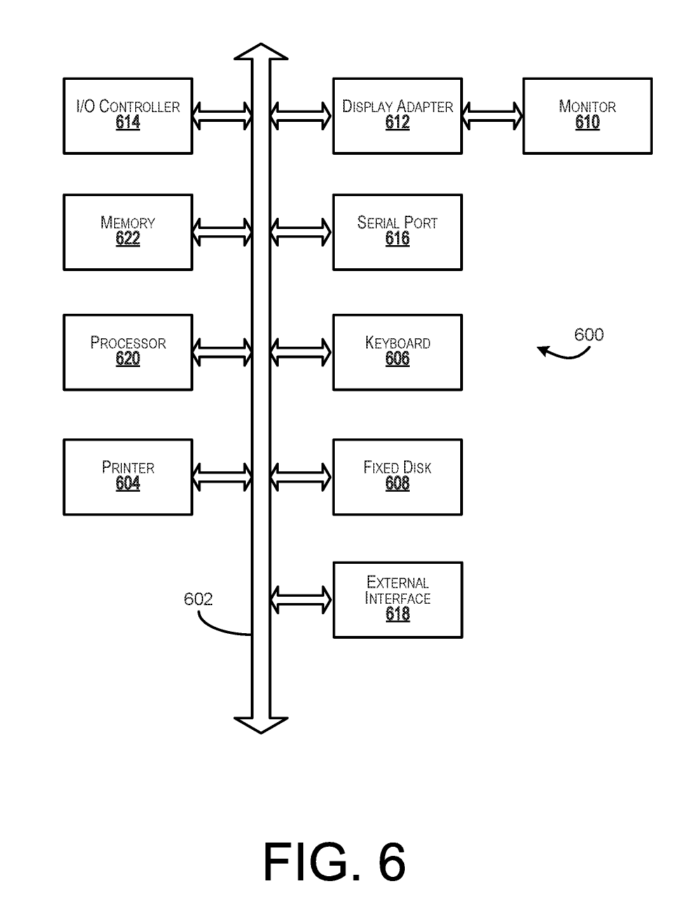

In accordance with at least some embodiments, the system, apparatus, methods, processes and/or operations for event processing may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 6 depicts aspects of elements that may be present in a computer device and/or system 600 configured to implement a method and/or process in accordance with some embodiments of the present invention. The subsystems shown in FIG. 6 are interconnected via a system bus 602. Additional subsystems such as a printer 604, a keyboard 606, a fixed disk 608, a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 6 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 608 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A computer-implemented method, comprising:
receiving, from an event source, at least one event notification associated with a user and an interaction;
providing a predictive model;
generating, using one or more machine learning techniques and based at least in part on the interaction, a prediction result set including at least one item;
updating the predictive model using at least the prediction result set;
providing, for presentation to the user, information related to the at least one item;
receiving an indication of accuracy related to the provided information; and
adjusting the one or more machine learning techniques based at least in part on the received indication of accuracy.

2. The computer-implemented method of claim 1, further comprising identifying at least one attribute value related to the user, wherein the prediction result set is generated based at least in part on the at least one attribute value related to the user.

3. The computer-implemented method of claim 2, wherein the at least one attribute value is one of a user's historical purchase data, location data, or network surfing data.

4. The computer-implemented method of claim 2, wherein the attribute values are identified from an account associated with the user.

5. The computer-implemented method of claim 1, wherein the prediction result set is generated within a specified period of time.

6. The computer-implemented method of claim 1, wherein the prediction result set is further filtered according to user preferences.

7. A system, comprising:
a processor; and
a storage for storing a predictive model;
a memory including instructions that, when executed by the processor, cause the system to, at least:
detect, from a user device, an event notification associated with an event occurring in relation to a user;
update the predictive model using at least the event notification;
identify a set of characteristics associated with the user;
determine, based at least in part on the event, a set of potential recommendations;
generate, from the set of potential recommendations, a subset of recommendations; and
present the subset of recommendations to the user.

8. The system of claim 7, wherein the set of potential recommendations is generated using one or more machine learning algorithms.

9. The system of claim 8, wherein the one or more machine learning algorithms is chosen based at least in part on an event type associated with the event notification.

10. The system of claim 7, wherein the set of potential recommendations is generated using at least two different machine learning algorithms and includes at least one potential recommendation determined from each of the different machine learning algorithms.

11. The system of claim 10, further comprising:
receiving feedback from the user; and
modifying at least one machine learning algorithm of the at least two different machine learning algorithms based at least in part on the received feedback.

12. The system of claim 11, wherein modifying at least one of the at least two different machine learning algorithms comprises adjusting one or more variables used by the at least one machine learning algorithm.

13. The system of claim 7, wherein the subset of recommendations are presented to the user by sending a notification to the user device.

14. A computer-readable storage medium storing computer-executable instructions that, when executed by a processor, cause a computer system to at least perform operations comprising:
receiving one or more event notifications from a single event source;
providing a predictive model;
identifying a user associated with the event source;
identifying, from an account associated with the identified user, attribute values relevant to a prediction result set;
determining, from the one or more event notifications, information indicative of user behavior;
generating, from the information indicative of user behavior and the attribute values, a prediction result set;
updating the predictive model using at least the predictive result list; and
presenting one or more results from the prediction result set to the user.

15. The computer readable medium of claim 14, wherein the user is identified based at least in part on a serial number, phone number, or account login information associated with the event source.

16. The computer readable medium of claim 14, wherein the information indicative of user behavior is determined by analyzing behavior patterns of a community of users.

17. The computer readable medium of claim 16, wherein the behavior patterns of the community of users include user interaction data and user purchasing data for the community of users.

18. The computer readable medium of claim 16, wherein the community of users is filtered to include only users of the community of users that are similar to the identified user.

19. The computer readable medium of claim 14, wherein the event sources is a mobile device.

20. The computer readable medium of claim 14, wherein the instructions further cause the computer system to at least add data from the event notification to data for the community of users.
